(19) United States
(12) Patent Application Publication
(10) Pub. No.: US 2005/0001997 A1
(43) Pub. Date: Jan. 6, 2005

(54) Projection-type image display

(76) Inventors: Satoru Kawaai, Saitama (JP); Takashi Watanabe, Saitama (JP)

Correspondence Address: Arnold International, P.O. Box 129, Great Falls, VA, 22066, US

(21) Appl. No.: 10/849,957

(22) Filed: May 21, 2004

(30) Foreign Application Priority Data
Jun. 9, 2003 (JP) 2003-164243

(51) Int. Cl. G03B 21/14

(52) U.S. Cl. 353/97

(57) ABSTRACT

A projection unit is provided with two stop-changing mechanisms, which are respectively disposed in an illumination optical system and a projection optical system to adjust an effective luminous-flux diameter. A stop controller controls the stop-changing mechanisms in accordance with a brightness level of an inputted video signal to make the effective luminous-flux diameter optimum. This diameter is adjusted so as to be large in a case of a high brightness level, and so as to be small in a case of a low brightness level. When the effective luminous-flux diameter is small, peripheral light of the luminous flux is cut so that contrast becomes high. A screen image is brightly displayed when a picture has the high brightness level, and is displayed in high contrast when the picture has the low brightness level.

### BACKGROUND OF THE INVENTION

1. Field of the Invention

The present invention relates to a projection-type image display of a video projector and so forth comprising an image-light producing device of a liquid-crystal element, a digital micromirror device (hereinafter, called as “DMD”) and so forth.

2. Description of the Related Art

A projection-type image display in which image light is projected to a screen is known. The image light is produced by receiving and modulating illumination light outputted from an illumination optical system. There are various kinds of the projection-type image displays in accordance with different optical modulation manners. For example, there are a liquid crystal projector and a DMD projector.

The liquid crystal projector comprises a liquid crystal element of a transmission type or a reflection type as an image-light producing section. As well known, the liquid crystal element includes a large number of liquid crystal cells arranged in matrix. The respective liquid crystal cells are driven on the basis of a video signal to carry out light modulation by polarizing the illumination light.

The DMD projector comprises a DMD as an image-light producing section. The DMD includes a large number of mirror elements arranged in matrix. The mirror element is changeable between an on-position, where the received illumination light is reflected toward a projection optical system, and an off-position, where the received illumination light is reflected in a direction straggling from the projection optical system, to change a reflection angle of the light. The mirror element is moved to the on-position when displaying a pixel brightly, and is moved to the off-position when displaying the pixel darkly. In this way, the reflex direction of the illumination light is controlled to carry out the light modulation in accordance with the video signal.

These projection-type image displays have a problem in that it is necessary to heighten intensity of a projection image in order to obtain a more visible screen image. This problem is on the load to resolution in virtue of recent technical progress. Particularly, the DMD uses the light efficiently in comparison with the liquid crystal element, since simple optical reflection of the mirror element is adopted for the light modulation. The DMD contributes to extremely high brightness of the projection image. The high-brightness screen image is very visible under a bright condition such that indoor lighting is turned on, but its contrast becomes vague under a dark condition such that the indoor lighting is turned off. Thus, there arises a problem in that the high-brightness screen image becomes invisible in the dark condition.

In consideration of the above, is proposed a projection-type image display having two display modes (see Japanese Patent Laid-Open Publication No. 2003-107396, for instance), one of which is a brightness emphasizing mode proper to a case of bright peripheral conditions, and the other of which is a contrast emphasizing mode proper to a case of dark peripheral conditions. Such a projection-type image display comprises a stop changing mechanism, which is disposed at an optical path of a projection unit. The display modes are changed by varying a stop diameter in two steps with the stop changing mechanism. In other words, the stop diameter is large under the brightness emphasizing mode and is small under the contrast emphasizing mode. As the stop diameter becomes larger, an effective luminous-flux diameter becomes large so that a picture having high brightness is obtained. Meanwhile, as the stop diameter becomes smaller, the effective luminous-flux diameter becomes small so that a light amount lowers. At the same time, a peripheral portion of the effective luminous flux is blocked so that scattering of light decreases and unfavorable light is reduced. In virtue of this, it is possible to obtain a picture having high contrast.

However, for some scenes of the screen images, sometimes it is proper to emphasize the brightness or the contrast without regard to bright and dark of the peripheral conditions. For example, when a brightness level of the screen image is high such as a scene having many white portions, high brightness is suitable for watching in spite of the dark peripheral conditions, since the white portions are clearly projected. Meanwhile, when the brightness level of the screen image is low such as a scene having many black portions, high contrast is suitable for watching in spite of the bright peripheral conditions, since the black portions are clearly projected. In the conventional projection-type image display, the display mode is changed in accordance with the peripheral conditions. Thus, there arises a problem in that some scenes of the screen images are sometimes uncomfortable for watching.

### SUMMARY OF THE INVENTION

In view of the foregoing, it is a primary object of the present invention to provide a projection-type image display in which a screen image suitable for watching is displayed in accordance with a picture scene.

In order to achieve the above and other objects, the projection-type image display according to the present invention comprises an illumination optical system, an image-light producing device and a projection optical system. The illumination optical system forms an illumination light. The image-light producing device optically modulates the illumination light in accordance with a video signal to produce an image light. The projection optical system projects the image light to a screen. The projection-type image display further comprises at least one stop-adjusting mechanism and a controller. The stop-adjusting mechanism is placed at a predetermined position of an optical path at which the illumination optical system and the projection optical system are disposed, to change an effective luminous-flux diameter at the predetermined position. The controller controls the stop-adjusting mechanism in accordance with a brightness level of the video signal.

It is preferable that the stop-adjusting mechanism consecutively changes a size of the effective luminous-flux diameter.

According to the projection-type image display of the present invention, the screen image suitable for watching is displayed in accordance with the brightness level of a picture.

### BRIEF DESCRIPTION OF THE DRAWINGS

The above objects and advantages of the present invention will become apparent from the following detailed description of the preferred embodiments of the invention when read in conjunction with the accompanying drawings, in which:

FIG. 1 is a perspective view of a projection-type image display;

FIG. 2 is an explanatory illustration showing a structure of a projection unit;

FIG. 3 is an illustration showing a structure of a stop-changing mechanism;

FIG. 4 is a graph showing a relationship between an effective luminous-flux diameter and a brightness level stored in an LUT; and

FIG. 5 is a flowchart showing a stop control procedure.

### DETAILED DESCRIPTION OF THE PREFERRED EMBODIMENT(S)

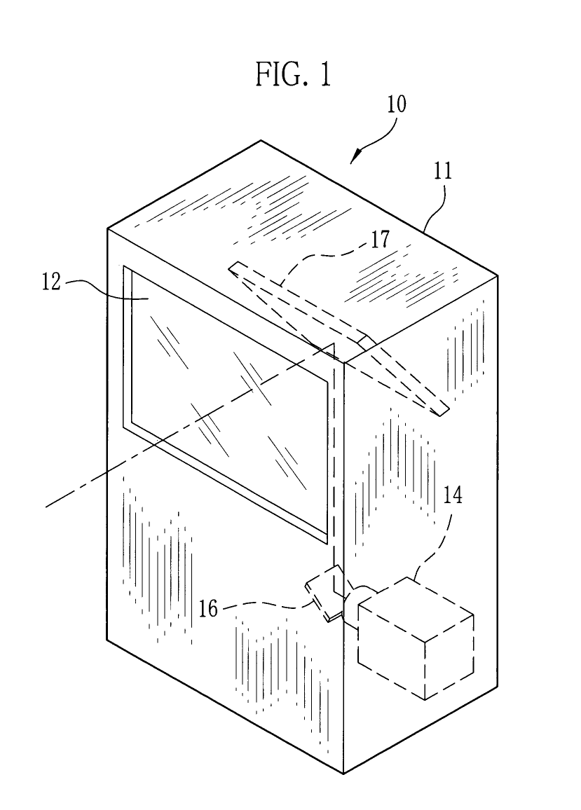

FIG. 1 shows an external appearance of a projection-type image display 10 provided with a screen 12 of a diffusion transmission type. The screen 12 is disposed at a front face of a housing 11. An image projected to a rear surface of the screen 12 is viewed from a front surface thereof. The housing 11 contains a projection unit 14, a projection image of which is reflected by mirrors 16 and 17 to be formed on the rear surface of the screen 12. It is possible to use the projection-type image display 10 as a large-sized television by driving a liquid crystal element, which is incorporated in the projection unit 14, on the basis of a video signal. In this case, the housing 11 includes a tuner circuit and a well-known circuit unit for reproducing the video signal and a sound signal.

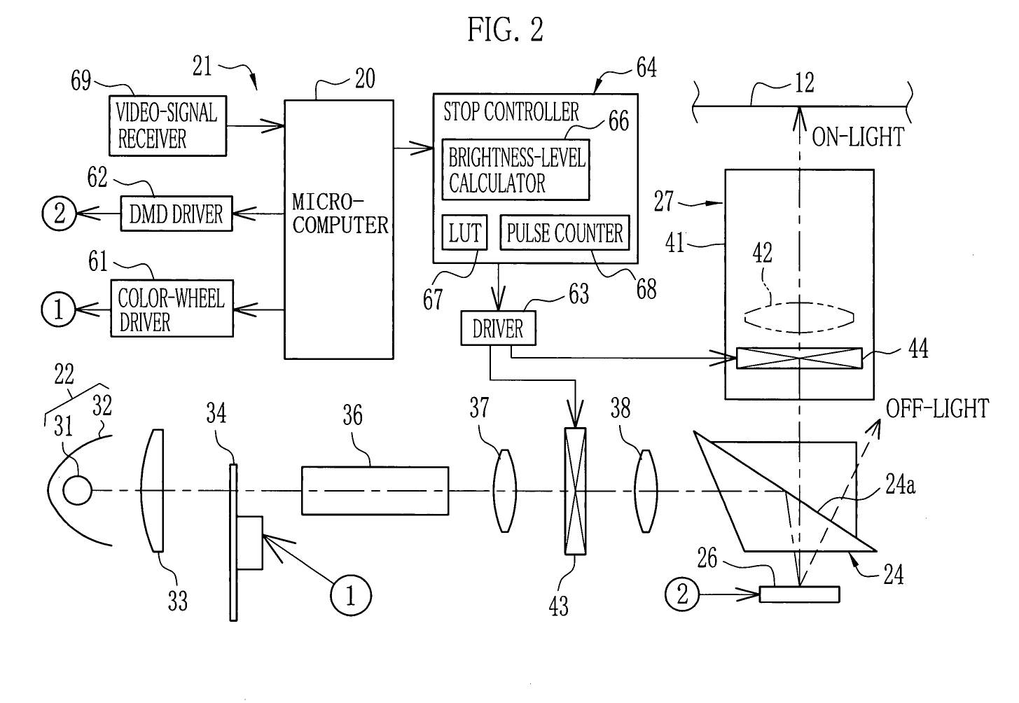

FIG. 2 schematically shows a structure of the projection unit 14. The projection unit 14 comprises a controller 21 and an optical system. The controller 21 includes a microcomputer 20. The optical system comprises a light-source unit 22, an illumination optical system, a total reflection prism 24, a DMD 26 and a projection optical system 27. The projection unit 14 adopts a single-plate style in that image lights of three colors are produced by the sole DMD 26. The controller 21 integrally controls each section of the projection unit 14 on the basis of the video signal inputted into a vide-signal receiver 69. Into this video-signal receiver 69, are inputted a composite signal, a component signal and so forth from the tuner circuit and a video-signal input terminal.

The light-source unit 22 comprises a light source 31 and a reflector 32 for reflecting an illumination light, which is emitted from the light source 31, toward the illumination optical system. As to the light source 31, a white-light source of a xenon tube, a mercury lamp and so forth are used, for example. The illumination optical system comprises a condenser lens 33, a color wheel 34, a rod integrator 36 and relay lenses 37 and 38.

The color wheel 34 separates a flux of the illumination light into three colors of B(blue), G(green) and R(red) in time division. The flux of the illumination light is radiated from the light-source unit 22 and is condensed by the condenser lens 33. The color wheel 34 is provided with thee-color filters of a B-filter, a G-filter and a R-filter, which are attached to a disk-like base at an identical distance from the center of the base. The B-filter transmits only the B-light. The G-filter transmits only the G-light. The R-filter transmits only the R-light. The color wheel 34 is driven by a color-wheel driver 61, and a rotational speed and rotation-commencing timing thereof are controlled by the microcomputer 20. The filters of the respective colors are selectively set to an optical path in order by rotating the color wheel 34. In virtue of this, the illumination light is separated into three colors of B, G and R in time division. The separated light of each color is radiated toward the DMD 26 in order.

The rod integrator 36 evens a density of the luminous flux of each color separated by the color wheel 34 so that light-intensity distribution of a light-receiving surface of the DMD 26 is evened from the center thereof to the periphery thereof. The rod integrator 36 is a rod made of glass, for example, in which a kaleidoscope is formed. The incident luminous flux of the rod integrator 36 repeats total reflection therein and is superposed. Thus, the luminous flux radiated from the rod integrator 36 has evened density.

The relay lenses 37 and 38 transmit the luminous flux, which is radiated from the rod integrator 36, to the total reflection prism 24. In this prism 24, the incident light advancing from the relay lenses 37 and 38 to the DMD 26 is separated from the reflex light reflected by the DMD 26. For example, the total reflection prism 24 is constituted of two triangle prisms having deferent refractive indexes. A reflecting plane 24a is formed at a border of the two triangle prisms. The incident light is wholly reflected by the reflecting plane 24a to enter the DMD 26, because an incident angle thereof is greater than a critical angle. Meanwhile, the reflex light reflected by the DMD 26 passes through the reflecting plane 24a, because an incident angle thereof is smaller than the critical angle.

The DMD 26 is driven by a DMD driver 62 connected to the microcomputer 20, on the basis of the video signal inputted into the projection unit 14. A large number of mirror elements corresponding to pixels are arranged in matrix on a light-receiving surface of the DMD 26. The respective mirror elements change their angles on the basis of the video signal to alter a reflex direction of the received illumination light. When displaying the pixel brightly, the mirror element is moved to an on-position to reflect the received light toward the projection optical system 27 as an on-light. Meanwhile, when displaying the pixel darkly, the mirror element is moved to an off-position to reflect the received light in a shifted direction from the projection optical system 27 as an off-light. The image light is constructed by a gather of the on-lights advancing to the projection optical system 27.

The projection optical system 27 is simplistically shown in the drawing such that a single projector lens 42 is disposed in a lens barrel 41. In fact, however, the projection optical system comprises a plurality of lens groups disposed at an optical axis, and a lens-moving mechanism for varying a magnification and adjusting a focus. The image light produced by the DMD 26 is projected on the screen 12 by means of the projection optical system 27.

First and second stop-changing mechanisms 43 and 44 are disposed at predetermined positions of the respective optical paths of the illumination optical system and the projection optical system. Each of the stop-changing mechanisms 43 and 44 changes brightness of the projection image by adjusting a size of an effective luminous-flux diameter.

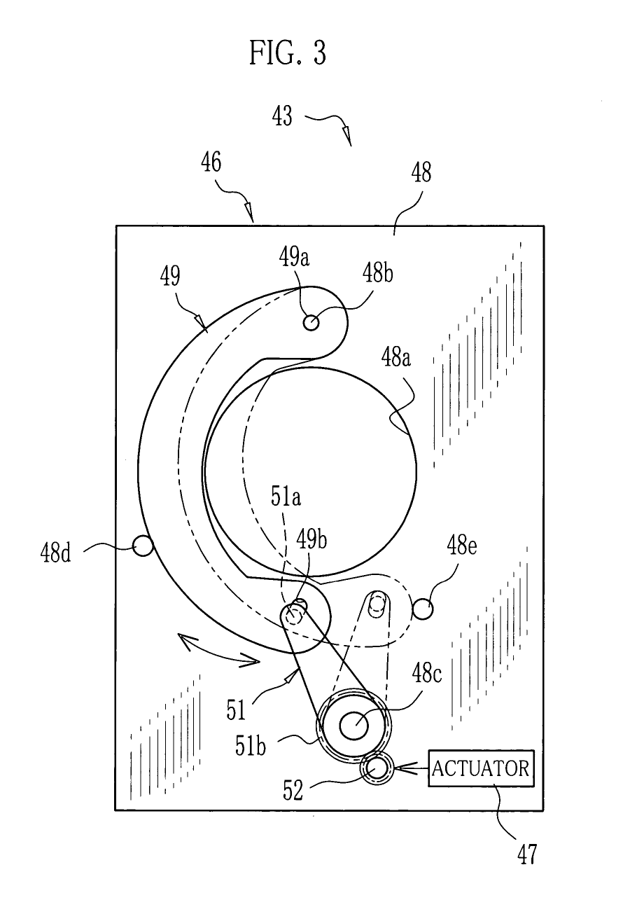

As shown in FIG. 3, the first stop-changing mechanism 43 comprises a main body 46 and an actuator 47. The main body 46 comprises a base plate 48, a stop blade 49 and a drive member 51. A central portion of the base plate 48 is formed with a stop aperture 48a through which the illumination light passes. The stop blade 49 has a crescent-like shape and covers a part of the stop aperture 48a to adjust the effective luminous-flux diameter. In other words, the stop blade makes a shape of the stop aperture 48a, which corresponds to the luminous flux of a pupil, a circular shape or an optimum shape by which best contrast is obtained. In this embodiment, the shape of the stop aperture is the circular shape or the waning moon shape. The drive member 51 actuates the stop blade 49. The main body 46 is disposed so as to make the center of the stop aperture 48a coincide with the optical axis. Further, in an optical-axis direction, the main body 46 is disposed at an effective position for working as an aperture of the luminous flux of the illumination optical system. For example, the main body 46 is disposed at an entrance-pupil position and an exit-pupil position of the illumination optical system, and at a near portion thereof.

On the base plate 48, a pin 48b for swingably supporting the stop blade 49 is provided near the stop aperture 48a. One end of the stop blade 49 is formed with a hole 49a into which the pin 48a is inserted. The other end of the stop blade 49 is formed with an elliptic hole 49b for engaging with a drive pin 51a of the drive member 51. The drive member 51 is swingably supported by a pin 48c formed on the base plate 48. Upon swinging the drive member 51, the drive pin 51a is moved. Since the drive pin 51a engages with the elliptic hole 49b, the stop blade 49 is rotated around the pin 48b.

The stop blade 49 is swung between an open-stop position (sown by a solid line in the drawing), where the stop blade 49 is evacuated to make the effective luminous-flux diameter maximum, and a minimum-stop position (shown by a double-dashed line in the drawing), where the stop blade 49 covers the periphery of the stop aperture 48a to make the effective luminous-flux diameter minimum. A swing range of the stop blade 49 is regulated by regulation pins 48d and 48e provided on the base plate 48. The drive member 51 is driven by the actuator 47. The drive member 51 is formed with a tooth row 51b meshing with a transmission gear 52. Rotational force of the actuator 47 is transmitted to the drive member 51 via the transmission gear 52. The stop blade 49 is swung between the open-stop position and the minimum-stop position, and a movement amount thereof consecutively changes in accordance with a rotational amount of the actuator 47.

For example, a pulse motor is used as the actuator 47. The pulse motor determines a rotational direction and a rotational amount in accordance with supplied drive pulses. The pulse motor is driven by a driver 63. It is needless to say that a DC motor may be used instead of the pulse motor. In this case, the rotational amount and the rotational direction are controlled by using a rotary encoder. By the way, the first stop-changing mechanism 43 is described in the above. The second stop-changing mechanism 44 has the similar structure so that description thereof is omitted.

A stop controller 64 determines the rotational direction and the rotational amount of the pulse motor on the basis of the inputted video signal so as to adjust the effective luminous-flux diameter consecutively. The stop controller 64 is provided with a brightness-level calculator 66, an LUT (look-up table) 67 and a pulse counter 68. The brightness-level calculator 66 calculates a brightness level of each frame on the basis of the received video signal. The brightness level is calculated to determine average brightness of the respective pixels constituting the frame. In other words, the brightness level is high with respect to the frame having many white portions, and the brightness level is low with respect to the frame having many black portions.

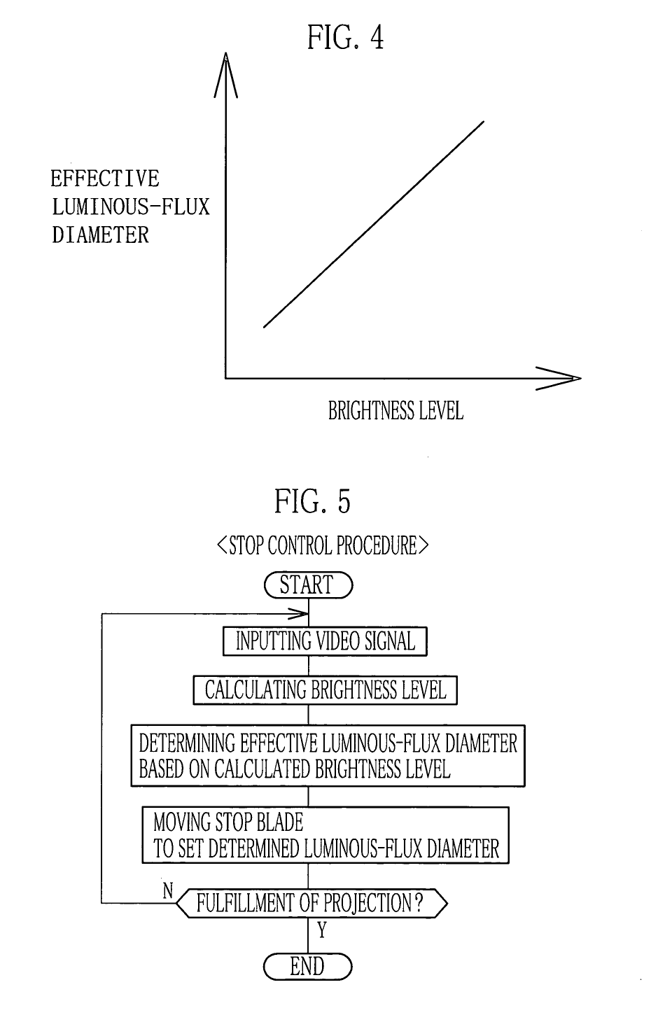

The LUT 67 stores in advance a relationship between the brightness level and the effective luminous-flux diameter corresponding to the brightness level. FIG. 4 is a graph showing this relationship. The effective luminous-flux diameter is adjusted so as to be large when the brightness level is high, and so as to be small when the brightness level is low. As to the screen image having a high brightness level, bright portions of the white portion and so forth are more brightened by emphasizing the brightness. Thus, the effective luminous-flux diameter is enlarged to increase the optical amount. Meanwhile, as to the screen image having a low brightness level, the black portion is clearly projected by lowering the brightness. Thus, the effective luminous-flux diameter is decreased to reduce the light amount. When the effective luminous-flux diameter is decreased, the periphery of the effective luminous flux is intercepted. In virtue of this, scattering of the light caused by the peripheral light is held down in the optical path and the unfavorable light is reduced. It is possible to enhance the contrast of the picture. Such adjustment of the effective luminous-flux diameter is carried out for the respective frames, for example.

By adjusting the effective luminous-flux diameter, the light amount is increased with respect to the scene having the high brightness level, and is decreased with respect to the scene having the low brightness level. Contrast of the respective scenes is consequently enhanced. According to an experiment, the following experimental result is obtained. White brightness is 700 lumen when the effective luminous-flux diameter is the maximum size, and black brightness is 0.2 lumen when the effective luminous-flux diameter is the minimum size. A ratio of the brightness is 3500 to 1. Contrast of a conventional projection-type image display is about 2500 to 1 at the maximum. It is understood from the above-mentioned experimental result that high contrast is obtained in comparison with the conventional image display.

The stop controller 64 reads the effective luminous-flux diameter corresponding to the brightness level obtained by the calculator 66, from the LUT 67. On the basis of the read luminous-flux diameter and the current position of the stop blade 49, the rotational direction of the pulse motor and the rotational amount thereof are determined. The driver 63 supplies the drive pulses to the pulse motor in accordance with the determined rotational amount and the determined rotational direction.

The pulse counter 68 counts the drive pulses supplied to the pulse motor. When the pulse motor is rotated in a predetermined forward direction, a count value is increased. On the other hand, when the pulse motor is rotated in a reverse direction, the count value is decreased. The stop controller 64 perceives the current position of the stop blade 49 on the basis of the count value.

Hereinafter, an operation of the above structure is described below, referring to a flowchart shown in FIG. 5. Upon inputting the video signal into the projection unit 14, the microcomputer 20 controls the respective sections to commence the projection. The DMD driver 62 drives the DMD 26 on the basis of the video signal. In synchronism with drive timing of the DMD 26, the color-wheel driver 61 rotates the color wheel 34. At the same time, the stop controller 64 performs the stop control via the driver 63.

As shown in FIG. 5, the stop controller 64 calculates the brightness level after the input of the video signal, and determines the optimum diameter of the effective luminous flux on the basis of the calculated brightness level. And then, the stop controller 64 moves the stop blade to set the determined diameter of the effective luminous flux. When the brightness level of the picture is high, the brighter image is projected on the screen 12. Meanwhile, when the brightness level of the picture is low, the screen image having high contrast is projected. The effective luminous-flux diameter is consecutively adjusted in accordance with the brightness level so that it is possible to display the optimum screen image suitable for watching.

In the above embodiment, the effective luminous-flux diameter is adjusted in accordance with the brightness level. In addition to this, the effective luminous-flux diameter may be determined in consideration of bright and dark of the peripheral conditions. Moreover, in the above embodiment, the stop-changing mechanism employs the sole stop blade. However, a plurality of stop blades may be employed. Further, although the stop-changing mechanisms are provided in both of the illumination optical system and the projection optical system, it is sufficient to provide either of them.

In the above embodiment, the DMD is used as the image-light producing device. However, liquid-crystal elements of a reflection type and a transmission type maybe used instead of the DMD. In this case, the structure of the optical system is changed in accordance with the liquid-crystal element. Moreover, the forgoing embodiment adopts the single-plate type in which the three-color image lights are produced by the sole image-light producing device. However, it is possible to adopt a three-plate type in which image-light producing devices are provided for the respective colors.

In the above embodiment, the pulse motor is used as the actuator 47. However, instead of the pulse motor, it is possible to use a blushless motor and a solenoid as the actuator 47.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A projection-type image display comprising:
an illumination optical system for forming an illumination light;
an image-light producing device for producing an image light by optically modulating the illumination light in accordance with a video signal;
a projection optical system for projecting said image light to a screen;
at least one stop-adjusting mechanism placed at a predetermined position of an optical path at which said illumination optical system and said projection optical system are disposed, said stop-adjusting mechanism changing an effective luminous-flux diameter at said predetermined position; and
a controller for controlling said stop-adjusting mechanism in accordance with a brightness level of said video signal.

2. A projection-type image display according to claim 1, wherein said stop-adjusting mechanism consecutively changes a size of said effective luminous-flux diameter.

3. A projection-type image display according to claim 2, wherein a number of said stop-adjusting mechanisms is two, one of which is a first stop-adjusting mechanism disposed in said illumination optical system and the other of which is a second stop-adjusting mechanism disposed in said projection optical system.

4. A projection-type image display according to claim 1, wherein said stop-adjusting mechanism comprises:
a stop aperture through which said illumination light passes;
a stop blade for making a shape of said stop aperture, which corresponds to a luminous flux of a pupil, one of a circular shape and an optimum shape by which best contrast is obtained;
a drive mechanism for driving said stop blade; and
an actuator for supplying a driving force to said drive mechanism.

5. A projection-type image display according to claim 4, wherein said controller determines an operational direction and an operational amount of said actuator on the basis of said brightness level of said video signal.

6. A projection-type image display according to claim 4, wherein said actuator is a pulse motor.

7. A projection-type image display according to claim 4, wherein said actuator is a brushless motor.

8. A projection-type image display according to claim 4, wherein said actuator is a solenoid.
